(19) United States
(12) Patent Application Publication
(10) Pub. No.: US 2015/0123547 A1
(43) Pub. Date: May 7, 2015

(54) LIGHTING SYSTEM

(71) Applicant: Panasonic Corporation, Osaka (JP)

(72) Inventor: Shigemi FUSHIMI, Osaka (JP)

(21) Appl. No.: 14/497,980

(22) Filed: Sep. 26, 2014

(30) Foreign Application Priority Data
Nov. 1, 2013 (JP) 2013-228782

(51) Int. Cl. H05B 37/02; A47F 11/10; F21V 33/00

(52) U.S. Cl. CPC H05B 37/0227; F21V 33/00; A47F 11/10; F21W 2131/405
USPC 315/155; 315/158

(57) ABSTRACT

A lighting system includes: a light source for lighting display and passage spaces; a first detector for detecting presence or absence of part of a human body in a first detection area; and a second detector for detecting human presence or absence in a second detection area. The second detection area contains a whole or part of the passage space. The first detection area is nearer to the article than the second detection area. A controller controls the light source so that: in a case of detecting human absence in which both of the first and second detectors detect human absence, the light source is operated at a reduced light output level; if the second detector detects human presence, illuminance in the display space is increased; and if the first detector detects human presence, illuminance in each of the passage space and the display space is increased.

### CROSS-REFERENCE TO RELATED APPLICATIONS

The application is based upon and claims the benefit of priority of Japanese Patent Application No. 2013-228782, filed on Nov. 1, 2013, the entire contents of which are incorporated herein by reference.

### TECHNICAL FIELD

The disclosure relates generally to lighting systems, and more particularly, to a lighting system configured to light displayed articles (goods, exhibits, and the like).

### BACKGROUND ART

Conventionally, there has been proposed a showcase including a lighting lamp for illumination in a display space and a control device configured to control the lighting lamp (for example, JP2006-266645A, hereinafter referred to as “Document 1”). In a showcase described in Document 1, a control device is configured to control a lighting state of a lighting lamp so that the lighting lamp decreases illuminance in a display space when an approach of a customer(s) is undetected and increases the illuminance in the display space when an approach of a customer(s) is detected.

In the showcase of Document 1, the illuminance in the display space is controlled according to movement of a customer(s). There is however a problem that optical output of a luminaire for lighting a space around the showcase cannot be controlled.

### SUMMARY

With the foregoing in view, it is an object of the disclosure to provide a lighting system capable of controlling illumination in a passage space and a display space according to movement of a human so that articles are visible to the human.

A lighting system according to one aspect of the invention includes: a light source configured to light a display space for displaying articles and a passage space facing the display space; a first detector configured to detect presence or absence of part of a human body in a first detection area; a second detector configured to detect human presence or absence in a second detection area; and a controller configured to control an optical output of the light source. The second detection area contains a whole or part of the passage space. The first detection area is set to a nearer side to the article than the second detection area. The controller is configured to control optical output of the light source so that: in a case of detecting human absence in which both of the first and second detectors detect human absence, the light source is operated at a reduced light output level in comparison with a case of detecting human presence in which at least one of the first and second detectors detects human presence; if the second detector detects human presence, illuminance in the display space is increased in comparison with the case of detecting human absence in which both of the first and second detectors detect human absence; and if the first detector detects human presence, illuminance in each of the passage space and the display space is increased in comparison with the case of detecting human absence in which both of the first and second detectors detect human absence.

In the lighting system, the optical output of the light source in the case of detecting human absence is smaller than that in the case of detecting human presence. Accordingly, energy consumption can be reduced. If the second detector detects human presence, the controller controls the optical output of the light source so that the luminance in the display space is increased. Thus, the articles displayed in the display space can be lit brightly, and the attention of a human in the passage space can be easily directed to the articles. If the first detector detects human presence, the controller controls the optical output of the light source so that the luminance in the passage space is increased. Thus, an article can be lit brightly to be seen easily in response to a motion of a human in the passage space for taking the article in one's hand.

### BRIEF DESCRIPTION OF THE DRAWINGS

The figures depict one or more implementations in accordance with the present teaching, by way of example only, not by way of limitations. In the figures, like reference numerals refer to the same or similar elements where:

FIGS. 1A and 1B are views illustrating a store to which a lighting system in an embodiment is applied, and FIG. 1C is a sectional view of a light source in the lighting system;

FIG. 2 is an external view of a luminaire in the lighting system;

FIG. 3 is a block diagram of the lighting system;

FIG. 4 is a view illustrating a store to which a lighting system according to a variation of the embodiment is applied;

FIGS. 5A to 5D are views each of which illustrates a store to which a lighting system according to a variation of the embodiment is applied;

FIG. 6 is a view illustrating a store to which a lighting system according to a variation of the embodiment is applied;

FIG. 7 is a planar view of the store to which the lighting system according to the variation is applied; and

FIG. 8 is a block diagram of a lighting system according to a variation of the embodiment.

### DETAILED DESCRIPTION

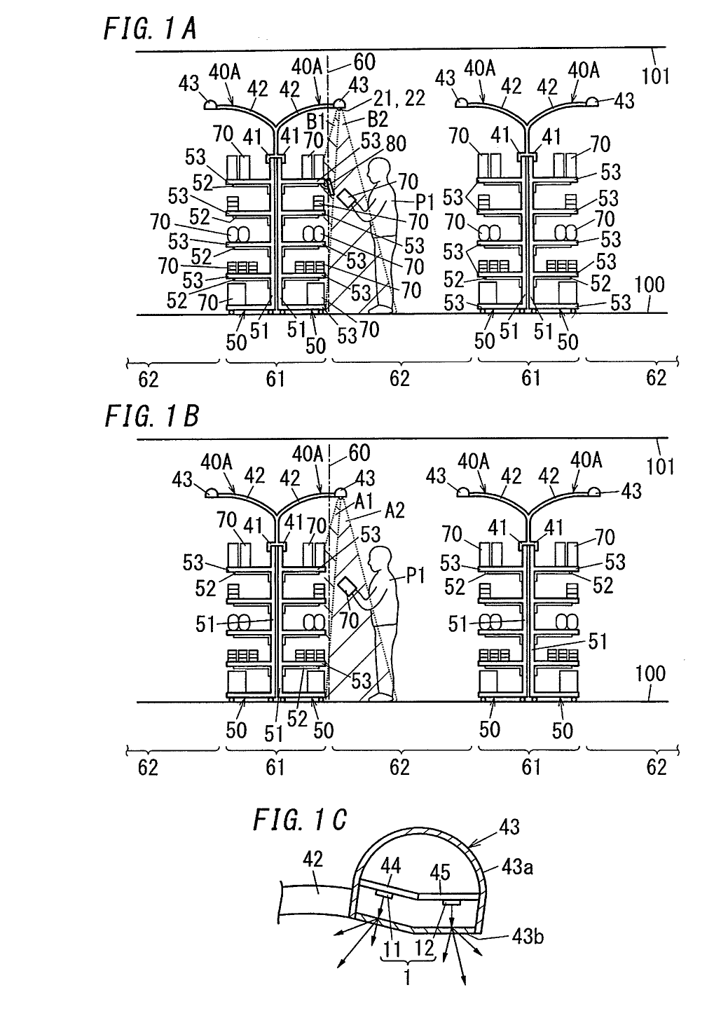

A lighting system in an embodiment is now explained with reference to FIGS. 1 to 8. The lighting system is applied to a retail store such as a convenience store, a drugstore, or a supermarket, in which showcases for displaying articles (goods) are placed.

FIGS. 1A and 1B show an example in which showcases 50 are placed in a store. All or a part of the showcases 50 may constitute one or more showcase set. Each showcase set includes two showcases 50 arranged back to back. In the example of FIGS. 1A and 1B, four showcases 50 are placed in the store, and the four showcases 50 constitute two showcase sets. Each of the showcase sets (each of the two showcase sets in the example of FIGS. 1A and 1B) is placed apart from a wall. In addition, each showcase 50 defines a display space 61 facing a passage space 62. Therefore, a front (a front side) of each showcase 50 faces a corresponding passage space. Hereinafter, one of the showcases 50 including the showcase sets is explained, and like explanation of the other is omitted.

A showcase 50 is formed of shelf boards 53, pillar members 51, beam members and the like, and has a width, a height and a depth. The shelf boards 53 each have horizontal surfaces at different heights. The pillar members 51 are arranged vertically at back sides of the shelf boards 53 so that the pillar members 51 have spaces between them in width directions of the shelf boards 53. The beam members 52 are each projected from the pillar members 51 to the front side to support the shelf boards 53 from their bottom sides. In the example of FIGS. 1A and 1B, the lowest shelf board 53 is joined to lower ends of the pillar members 51, and remaining shelf boards 53 are supported by the beam members 52. Two or more backboards (not shown) are attached among the pillar members 51.

The showcase 50 is used for displaying articles (goods) 70 such as food, clothing and stationery, and some articles 70 are displayed on each shelf board 53. That is, spaces at upper surface sides of the shelf boards 53 of the showcase 50 constitute a display space 61 for displaying the articles 70.

In the example of FIGS. 1A and 1B, one showcase set includes two showcases 50 arranged back to back, and two showcase sets are arranged so that they have a prescribed space (a passage space) between them and their width directions are parallel with each other. An open space in front of each showcase 50 is a passage space 62 for people to walk on. That is, a display space 61 for displaying articles 70 of each showcase 50 faces a passage space 62.

However, the structure of each showcase 50 for displaying articles 70 is not limited to the structure shown in FIGS. 1A and 1B. Kinds, materials, color tones, sizes and the like of members constituting the showcase 50 can be appropriately modified. For example, each (or at least one) shelf board 53 may be formed of a light guide plate. In the example of FIGS. 1A and 1B, articles 70 are placed on each shelf board 53, but a display form for articles 70 is not limited to the example. Examples of the display form include a display form in which article 70 are hanged on hooks, and a display form in which articles 70 are hanged from an upside. Utensils according to a display form may be used.

FIG. 3 shows a block diagram of a lighting system in the embodiment. In the example of FIGS. 1A and 1B, lighting systems are installed to respective showcases 50. Hereinafter, one of the lighting systems is explained, and like explanation of the other is omitted. The lighting system includes a light source 1, a first detector 21, a second detector 22, and a controller 30. The lighting system further includes a first lighting circuit 13 and a second lighting circuit 14.

The light source 1 is configured to light a display space 61 and a passage space 62. In the embodiment, the light source 1 includes a first light source 11 configured to mainly light the display space 61, and a second light source 12 configured to mainly light the passage space 62.

The first light source 11 is a linear light source including light-emitting diodes that are linearly arranged, and is placed along a width direction of the showcase 50. A lighting area (a first lighting area) A1 of the first light source 11 (see FIG. 1B) is set so that the first light source 11 lights, from a side of the passage space 62, part of the display space 61 on a side of the passage space 62. That is, the first light source 11 is configured to light, from the side of the passage space 62, a (imaginary) boundary face 60 between the display space 61 and the passage space 62. In order to direct attention of a human in the passage space 62 to articles 70, vertical illuminance to the articles 70 needs to be increased. It is therefore preferable that front sides of the articles 70 be lit from top to bottom thereof at a uniform illumination level. The front sides of the articles 70 are regions thereof which can be seen from a human in the passage space 62. It is also preferable that light distribution of the first light source 11 be set so as to prevent output light of the first light source 11 from directly entering eyes of a human looking at some articles 70. Therefore, the first light source 11 is configured to emit light diagonally downward from a front side of the articles 70 to light articles 70 such that a human in front of the showcase 50 can easily recognize characters or graphics depicted in the articles 70 or the articles 70 themselves displayed on the showcase 50. In the embodiment, the first light source 11 is formed of light-emitting diodes. It is preferable that the first light source 11 be formed of a light source configured to emit light having high color temperature and high color rendering property. For example, electroluminescence devices or a fluorescent lamp(s) may be used for the first light source 11.

The second light source 12 is formed of a linear light source including light-emitting diodes that are linearly arranged, and is placed along the width direction of the showcase 50. A lighting area (a second lighting area) A2 of the second light source 12 (see FIG. 1B) is set to part of the passage space 62 (a region near to the display space 61). However, the lighting area A2 of the second light source 12 may be a whole of the passage space 62 in a case where the passage space 62 has a comparatively narrow width. In order that a human in the passage space 62 can easily recognize an article 70 that is taken in hand from articles 70 displayed on the showcase 50, horizontal illuminance to the article 70 needs to be increased. Therefore, the second light source 12 is configured to emit light downward from an upper side of the article 70 to light the article 70 such that a human in front of the showcase 50 can easily recognize characters or graphics depicted in the article 70 or the article 70 itself taken in hand from the articles displayed on the showcase 50. In the embodiment, the second light source 12 is formed of light-emitting diodes. It is preferable that the second light source 12 be formed of a light source configured to emit light having high color temperature and high color rendering property. For example, electroluminescence devices or a fluorescent lamp(s) may be used for the second light source 12.

Returning to FIG. 3, the first lighting circuit 13 is configured to supply electric power to the first light source 11 to operate the first light source 11.

The second lighting circuit 14 is configured to supply electric power to the second light source 12 to operate the second light source 12.

Each of the first and second detectors 21 and 22 includes a pyroelectric infrared detector, and is configured to detect human presence or absence in a detection area by sensing thermal rays emitted from a human body. The first and second detectors 21 and 22 are not limited to a sensor that senses infrared rays emitted from a human body, and may be another sensor such as an ultrasonic sensor, microwave sensor, or a sonic sensor.

The controller 30 is configured to control optical outputs of the first and second light sources 11 and 12 by controlling outputs (output levels) of the first and second lighting circuits 13 and 14 based on detection results of the first and second detectors 21 and 22.

The embodiment includes a device body 40A attached to a top of the showcase 50. The device body (luminaire body) 40A houses a light source 1 (the first light source 11 and the second light source 12), the first detector 21, the second detector 22, the controller 30, the first lighting circuit 13 and the second lighting circuit 14. The light source 1, the first detector 21, the second detector 22, the controller 30, and the device body 40A constitute a luminaire.

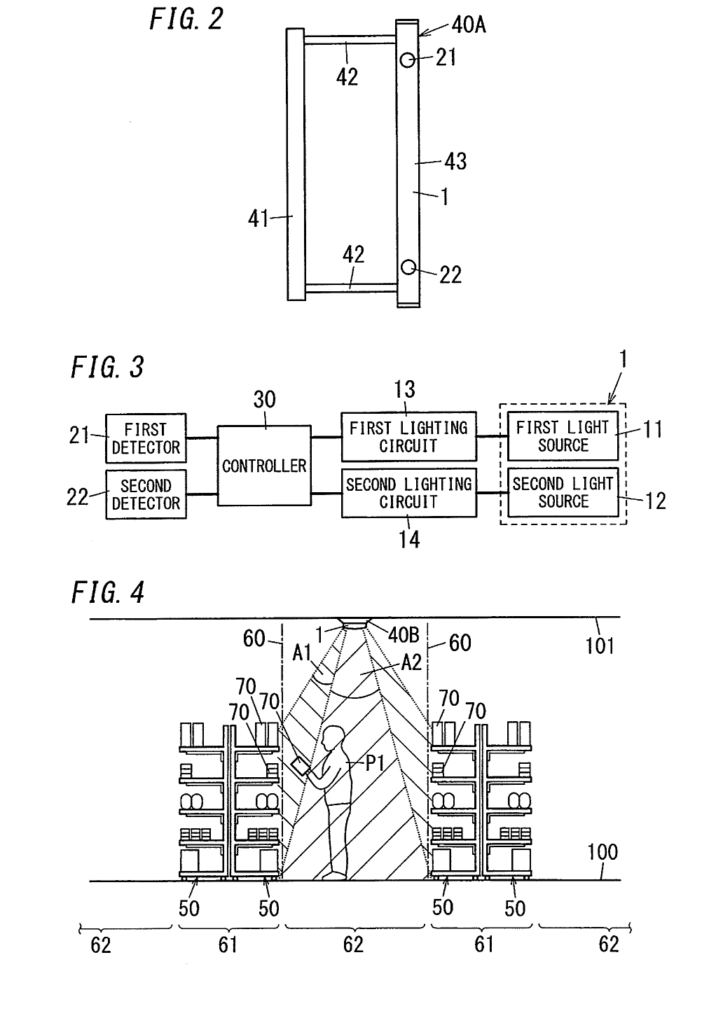

As shown in FIGS. 1A to 2, the device body 40A is attached to the top of the showcase 50. FIG. 2 illustrates an appearance of the device body 40A seen from a bottom side thereof. The device body 40A shown in FIG. 2 is used for a showcase 50 not constituting a showcase set, and includes a base 41, two arms 42 and a lamp body (a housing) 43. A device body for a showcase set further includes two arms 42 and a lamp body 43 for another showcase 50 (see FIG. 1A). Hereinafter, the device body 40A for the showcase 50 is explained, and like explanation about the two arms 42 and the lamp body 43 for another showcase 50 is omitted.

The base 41 is attached to top ends of the pillar members 51 at both ends so as to form a bridge.

Base sides of the two arms 42 are each extended upward from both ends of the base 41 in the width direction of the showcase 50. Tip sides of the arms 42 have the same shape as seen from one side of the width direction of the showcase 50, and are each curved so that the tip sides more project forward as the tip sides are more apart from the base 41. The lamp body 43 is joined to the tips of the arms 42, and is supported by the base 41 through the arms 42.

As shown in FIG. 1C, the lamp body 43 includes a case 43a that has a lower opening and extends in the width direction of the showcase 50, and a light-transmitting cover 43b that closes the lower opening of the case 43a. Circuit boards 44 and 45 extend in the width direction of the showcase 50 and are housed in the case 43a. The light-emitting diodes constituting the first light source 11 are mounted on a lower surface of the circuit board 44 (a first circuit board) so as to have regular spaces between them in the width direction of the showcase 50. The light-emitting diodes constituting the second light source 12 are mounted on a lower surface of the circuit board 45 (a second circuit board) so as to have regular spaces between them in the width direction of the showcase 50. In order to allow the second light source 12 to emit light downward, the second circuit board 45 is housed in the case 43a so that the second circuit board 45 becomes horizontal with the light-emitting surface thereof facing downward when the device body 40A is attached to the showcase 50. In order to allow the first light source 11 to emit light diagonally downward, the first circuit board 44 is housed in the case 43a so that the first circuit board 44 is inclined with respect to a horizontal plane with the light-emitting surface thereof facing diagonally downward when the device body 40A is attached to the showcase 50. Thus, since the first and second light sources 11 and 12 have light-emitting directions that are set to downward directions, it is possible to suppress the possibility that light emitted from each of the first and second light sources 11 and 12 enters human eyes, thereby preventing glare and reducing an unfavorable influence onto the atmosphere of store space.

For example, the light source 1 including the second light source 12 is placed at a height of about 200 [cm] from the floor 100 based on an adult average height so that from a near place the second light source 12 can light an article 70 which a human P1 in the passage space 62 takes in hand. Since the lamp body 43 including the light source 1 is attached to the top of the showcase 50, it is possible to reduce a distance between the articles 70 and the light source 1 to reduce luminous flux of the light source 1 in comparison with a case where the light source 1 is placed on the ceiling 101 that is equal to or higher than 3 [m]. As a result, energy consumption can be reduced. In the embodiment, the lamp body 43 housing the light source 1 is installed above the showcase 50, but the installation location thereof is not limited to this. In a case where the height of the showcase 50 is high, the light source 1 may be installed at a position of the showcase 50 of which height from the floor 100 is equal to or lower than the height of 200 [cm] and higher than the average height.

As shown in FIG. 2, the first and second detectors 21 and 22 are provided on both ends in a longitudinal direction of the lamp body 43, respectively.

The second detector 22 is configured to detect human presence or absence in a detection area (a second detection area) B2 that contains a whole or part of the passage space 62. As shown in FIG. 1A, in a case where the passage space 62 has a sufficient width for two humans passing each other, the detection area B2 of the second detector 22 is set to part of the passage space 62 near the showcase 50 to which the device body 40A is installed. In a case where the passage space 62 has a comparatively narrow width, the detection area B2 of the second detector 22 may be set to a whole of the passage space 62.

The first detector 21 is configured to detect human presence or absence in a detection area (a first detection area) B1 (see FIG. 1A) which is set to a nearer side to the articles 70 than the second detection area B2 in the passage space 62. The detection area B1 of the first detector 21 is set so that the first detector 21 does not detect presence of a human when the human is passing through the passage space 62. In the example of FIG. 1A, the first detection area B1 contains the boundary face 60 between the display space 61 and the passage space 62.

That is, the first detector 21 is configured to detect presence or absence of part of a human body in the first detection area Bl. The first detection area B1 is set to a nearer side to the articles 70 than the second detection area B2.

In a preferred example, the lamp body 43 is provided with two or more first detectors 21 and two or more second detectors 22. The first detectors 21 and the second detectors 22 may be alternately arranged in the width direction of the showcase 50.

The controller 30 is configured to control the light quantities of the first and second light sources 11 and 12 based on the detection results of the first and second detectors 21 and 22. A control operation thereof is now explained.

In a case where no human is present in the detection areas B1 and B2 and thus both of the first and second detectors 21 and 22 detect human absence (i.e., in a case of detecting human absence), the controller 30 controls the outputs (the output levels) of the first and second lighting circuits 13 and 14 to operate the first and second light sources 11 and 12 at a reduced level. In the embodiment, in the case of detecting human absence, electric currents supplied to the first and second light sources 11 and 12 are decreased. That is, in the case of detecting human absence, the first and second light sources 11 and 12 are lit at first and second light output levels with reduced light intensities, thereby reducing power consumption.

If a human P1 comes in the detection area B2 of the second detector 22, the second detector 22 detects human presence in the second detection area B2 and supplies the controller 30 with a human detection signal representing human presence in the second detection area B2. If receiving the human detection signal from the second detector 22, the controller 30 determines that a human P1 is present in the passage space 62 near the showcase 50, and controls the output of the first lighting circuit 13 so that the optical output of the first light source 11 increases from the first light output level to a third light output level. In the embodiment, if the second detector 22 detects human presence in the second detection area B2, the electric current supplied to the first light source 11 is increased. If the optical output of the first light source 11 is increased to the third light output level, the articles 70 displayed on the shelf boards 53 are lit more brightly than the around region, and accordingly the attention of a human in the passage space 62 can be directed to the articles 70. As an example, when increasing the optical output of the first light source 11, the controller 30 may increase the optical output while changing a color temperature of the optical output from a low color temperature to a high color temperature.

If a human P1 in the passage space 62 stretches one's hand to take an article 70 displayed on a shelf board 53 of the showcase 50, part of a human body enters the detection area B1 of the first detector 21. If detecting part of the human body in the detection area B1, the first detector 21 supplies the controller 30 with a human detection signal representing presence of part of a human body in the detection area B1. If receiving the human detection signal from the first detector 21, the controller 30 determines that a human P1 stretches one's hand into the display space 61 to take an article 70, and then controls the output of the second lighting circuit 14 to increase the optical output of the second light source 12 from the second light output level to a fourth light output level. In the embodiment, if the first detector 21 detects human presence (presence of part of a human body) in the first detection area B1, the electric current supplied to the second light source 12 is increased. In this case, the optical outputs of the first and second light sources 11 and 12 are increased in comparison with a case where presence of a human and part of a human body is not detected. As a result, the lighting areas A1 and A2 are lit brightly. Therefore, the article 70 taken in one's hand is lit brightly by light emission of the second light source 12, and can be accordingly easy to see. As an example, when increasing the optical output of the second light source 12, the controller 30 may increase the optical output while changing a color temperature of the optical output from a low color temperature to a high color temperature. The second light output level may be brighter than, darker than, or equal to the first light output level. The fourth light output level may be brighter than, darker than, or equal to the third light output level.

If a predetermined time elapses from a point in time at which the human detection signal is supplied from the first detector 21, the controller 30 controls the output of the second lighting circuit 14 so as to decrease the optical output of the second light source 12 from the fourth light output level to the second light output level. It is preferable that when decreasing the optical output of the second light source 12 from the fourth light output level to the second light output level, the controller 30 gradually change the optical output at a speed such that the change in the optical output is imperceptible and the atmosphere of the store space is not spoiled. As an example, when decreasing the optical output of the second light source 12, the controller 30 may decrease the optical output while changing a color temperature of the optical output from the high color temperature to the low color temperature.

Subsequently, if the human P1 in the passage space 62 moves outside the detection area B2, both of the first and second detectors 21 and 22 come to detect human absence, so that the first and second detectors 21 and 22 stop supplying any human detection signal to the controller 30. Thus, if a predetermined time elapses from a point in time at which the first and second detectors 21 and 22 stop supplying any human detection signals to the controller 30, the controller 30 controls the output of the first lighting circuit 13 so as to decrease the optical output of the first light source 11 from the third light output level to the first light output level. It is preferable that when decreasing the optical output of the first light source 11 from the third light output level to the first light output level, the controller 30 gradually change the optical output at a speed such that the change in the optical output is imperceptible and the atmosphere of the store space is not spoiled. As an example, when decreasing the optical output of the first light source 11, the controller 30 may decrease the optical output while changing a color temperature of the optical output from the high color temperature to the low color temperature.

It is preferable that the lighting system further include an information device 80 (such as a tablet terminal). As shown in FIG. 1A, the information device 80 may be attached to the showcase 50 and configured to notify of information about articles 70 displayed on each shelf board 53 by video or audio. A notification operation of the information device 80 may be controlled by the controller 30. For example, the controller 30 and the information device 80 have a wireless communication function, and the controller 30 is configured to wirelessly transmit a control signal to the information device 80. The controller 30 is configured, if receiving a human detection signal from the second detector 22, to wirelessly transmit a control signal for allowing the information device 80 to start notification operation. The information device 80 is configured, if receiving the wirelessly transmitted control signal, to start the notification operation based on the control signal. As a result, the information about the articles 70 can be provided to a human P1 in the passage space 62. It is preferable that, if a predetermined time elapses from a point in time at which the second detector 22 stops supplying the human detection signal to the controller 30, the controller 30 wirelessly transmit a control signal for allowing the information device 80 to stop the notification operation. If receiving this control signal, the information device 80 stops the notification operation. The information device 80 automatically stops the notification operation in response to human absence, and accordingly power consumption can be reduced. Preferably, when stopping the notification operation, the information device 80 is configured to perform a fadeout operation to gradually decrease sound volume at a speed such that the change in sound volume is imperceptible. For example, customers in a store can be prevented from having a sense of discomfort.

As described above, the lighting system in the embodiment includes the light source 1, the first detector 21, the second detector 22 and the controller 30. The light source 1 is configured to light the display space 61 for displaying articles 70 and a passage space 62 facing the display space 61. The second detector 22 is configured to detect human presence or absence in a second detection area B2. The second detection area B2 contains a whole or part of the passage space 62. The first detector 21 is configured to detect presence or absence of part of a human body in a first detection area B1. The first detection area B1 is set to a nearer side to the article 70 than the second detection area B2. The controller 30 is configured to control the optical output of the light source 1. The controller 30 is configured to control the light source 1 so that: in a case of detecting human absence in which both of the first and second detectors 21 and 22 detect human absence, the light source 1 is operated at a reduced light output level in comparison with a case of detecting human presence in which at least one of the first and second detectors 21 and 22 detects human presence; if the second detector 22 detects human presence, the light source 1 increases illuminance in the display space 61 in comparison with the case of detecting human absence in which both of the first and second detectors 21 and 22 detect human absence; and if the first detector 21 detects human presence, the light source 1 increases illuminance in both of the passage space 62 and the display space 61 in comparison with the case of detecting human absence in which both of the first and second detectors 21 and 22 detect human absence.

Since the optical output of the light source 1 in the case of detecting human absence is smaller than that in the case of detecting human presence, energy consumption can be reduced. If the second detector 22 detects human presence, the controller 30 controls the optical output of the light source 1 so that the luminance in the display space 61 is increased. Thus, the articles 70 displayed in the display space 61 can be lit brightly and the attention of a human in the passage space 62 can be directed to the articles 70. If the first detector 21 detects human presence, the controller 30 controls the optical output of the light source 1 so that the luminance in the passage space 62 is increased. Thus, an article 70 can be lit brightly and to be seen easily in response to a motion of a human in the passage space 62 for taking the article 70 in one's hand.

In the lighting system of the embodiment, the light source 1 includes: a first light source 11 configured to mainly light the display space 61; and a second light source 12 configured to mainly light the passage space 62. The controller 30 is configured: in the case of detecting human absence in which both of the first and second detectors 21 and 22 detect human absence, to decrease optical outputs of the first and second light sources 11 and 12 in comparison with the case of detecting human presence in which at least one of the first and second detectors 21 and 22 detects human presence; if the second detector 22 detects human presence, to increase the optical output of the first light source 11 in comparison with the case of detecting human absence in which both of the first and second detectors 21 and 22 detect human absence; and if the first detector 21 detects human presence, to increase the optical outputs of both of the first and second light sources 11 and 12 in comparison with the case of detecting human absence in which both of the first and second detectors 21 and 22 detect human absence.

In detail, the controller 30 is configured: in the case where both of the first and second detectors 21 and 22 detect human absence, to light the first and second light sources 11 and 12 at first and second light output levels, respectively; if the second detector 22 detects human presence, to light the first light source 11 at a third light output level brighter than the first light output level; and if the first detector 21 detects human presence, to light the second light source 12 at a fourth light output level brighter than the second light output level.

In the case of detecting human absence, the controller 30 operates the first and second light sources 11 and 12 at a reduced level in comparison with the case of detecting human presence, and accordingly energy consumption can be reduced. If the second detector 22 detects human presence, the controller 30 increases the optical output of the first light source 11. Thus, the articles 70 displayed in the display space 61 can be lit brightly and the attention of a human in the passage space 62 can be directed to the articles 70. If the first detector 21 detects human presence, the controller 30 increases the optical output of the second light source 12. Thus, if a human in the passage space 62 takes an article 70 in one's hand, the article 70 can be seen easily because the article 70 is lit brightly.

In the lighting system of the embodiment, the first light source 11 is configured to light, from a side of the passage space 62, a boundary face 60 between the display space 61 and the passage space 62.

When a human comes in the passage space 62, the vertical illuminance to the articles 70 can be increased. Accordingly, the attention of the human coming in the passage space 62 can be effectively directed to the articles 70.

The lighting system of the embodiment includes the information device 80 that is placed in the display space 61 and configured to notify of information related to the articles 70 displayed in the display space 61. The controller 30 is configured to cause the information device 80 to provide the information on the articles 70 if the second detector 22 detects human presence. It is therefore possible to provide information related to the articles 70 to the human in the passage space 62.

In this lighting system, the first and second detectors 21 and 22 are formed of individual two sensors.

In addition, the lighting system includes the device body 40A that includes the base 41, the lamp body (the housing) 43, and the arm 42 connecting the base 41 and the housing 43. The base 41 is attached to the showcase 50 which defines the display space 61. The arm 42 extends from a side of the display space 61 to a side of the passage space 62 so that the housing 43 is placed above the passage space 62. The first light source 11, the second light source 12, the first detector 21 and the second detectors 22 are provided to the housing 43. The first light source 11 is configured to emit light diagonally downward from the housing 43 to the display space 61. The second light source 12 is configured to emit light downward from the housing 43 to the passage space 62.

Incidentally, in the example of FIGS. 1A and 1B, the light source 1 and the like are housed in the device body 40A and the device body 40A is installed to the showcase 50, but the embodiment is not limited thereto. For example, as shown in FIG. 4, a light source 1 (a first light source 11 and a second light source 12) and the like may be housed in a device body 40B and the device body 40B may be installed to a ceiling 101.

In short, the lighting system according to the example of FIG. 4 includes a device body 40B that houses the first light source 11, the second light source 12, the first detector 21 and the second detectors 22. The device body 40B is installed to a ceiling 101, above the passage space 62, of a room in a building. The first light source 11 is configured to emit light diagonally downward from the device body 40B to the display space 61. The second light source 12 is configured to emit light downward from the device body 40B to the passage space 62.

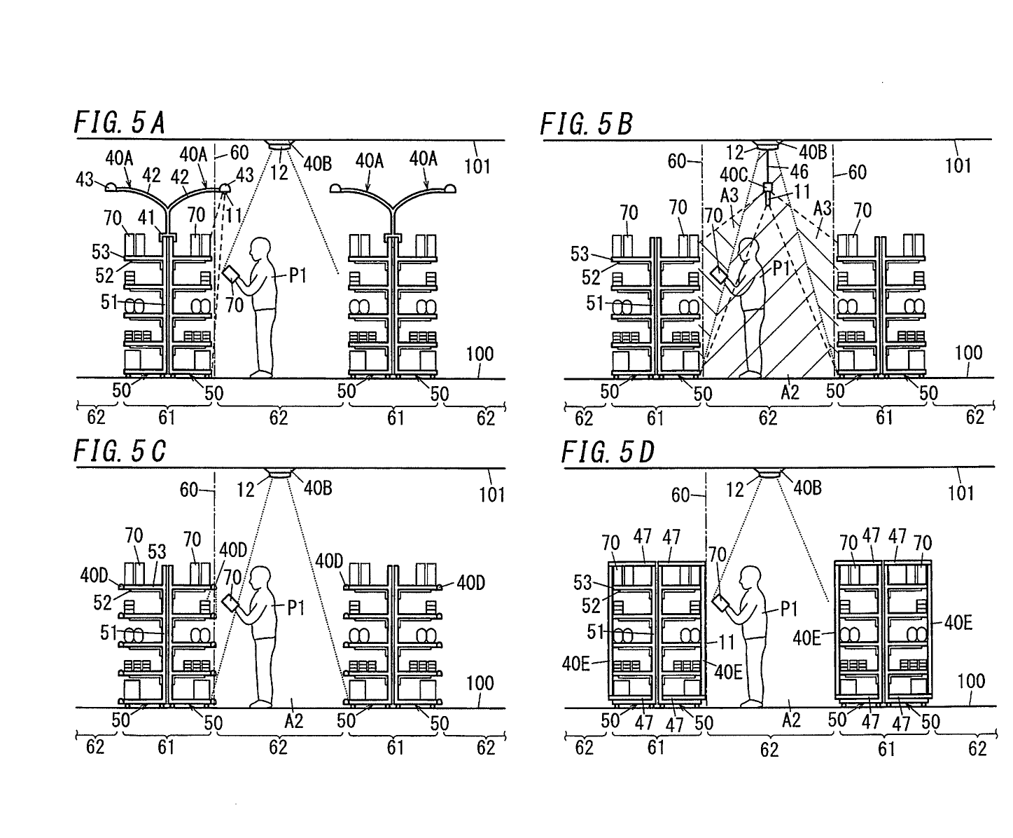

In the example of FIGS. 1A and 1B, the first and second light sources 11 and 12 are housed in the same device body 40A, but the embodiment is not limited thereto. Respective first and second light sources 11 and 12 may be housed in different device bodies. For example, as shown in FIGS. 5A to 5D, a lighting system may include a first device body and a second device body 40B different from the first device body. The first light source 11 and a first lighting circuit 13 may be housed in the first device body. The second light source 12 and a second lighting circuit 14 may be housed in the second device body 40B installed to a ceiling 101.

In each of the examples of FIGS. 5A to 5D, the second light source 12 is housed in the second device body 40B that is installed to the ceiling 101. The second light source 12 is configured to light an entire region of a passage space 62 between showcases 50 that are placed on opposite sides of the passage space 62. That is, in each of these examples, a lighting area (a second lighting area) A2 of the second light source 12 is set to a whole of the passage space 62. In each of the examples of FIGS. 5A to 5D, a detection area B2 of a second detector 22 is set to a whole of the passage space 62, and the second detector 22 is configured to detect human presence or absence in the passage space 62. If the second detector 22 detects human presence, a controller 30 increases an optical output of the first light source 11 in comparison with a case of detecting human absence, so that articles 70 displayed in display spaces 61 on opposite sides of the passage space 62 are lit more brightly. The controller 30, a first detector 21 and the second detector 22 may be provided to the first device body in which the first light source 11 is housed or the second device body 40B in which the second light source 12 is housed.

In the example of FIG. 5A, a first light source 11, a first lighting circuit 13, a controller 30 and a first detector 21 are housed in a device body (a first device body) 40A that is installed to a top of a showcase 50. In this example, the controller 30 housed in the device body 40A and a second lighting circuit 14 housed in a device body (a second device body) 40B have a wireless communication function, and the controller 30 is configured to wirelessly transmit a control signal to the second lighting circuit 14. If the first detector 21 detects human presence in a first detection area B1 (see FIG. 1A) and supplies the controller 30 with a human detection signal, the controller 30 wirelessly transmits, to the second lighting circuit 14, a control signal for increasing an optical output of a second light source 12. Then, the second lighting circuit 14 increases the optical output of the second light source 12 based on the received control signal. Control operation of the controller 30 is similar to that in the lighting system of the example of FIGS. 1A and 1B, and detailed explanation thereof is omitted.

In short, the lighting system according to the example of FIG. 5A includes the first device body 40A that houses the first light source 11 and the second device body 40B that houses the second light source 12. The first device body 40A includes a base 41, a lamp body (a housing) 43, and an arm 42 connecting the base 41 and the housing 43. The base 41 is attached to the showcase 50 which defines the display space 61. The arm 42 extends from a side of the display space 61 to a side of the passage space 62 so that the housing 43 is placed above the passage space 62. The first light source 11 is provided to the housing 43. The second device body 40B is installed to a ceiling 101, above the passage space 62, of a room in a building. The first light source 11 is configured to emit light diagonally downward from the housing 43 to the display space 61. The second light source 12 is configured to emit light downward from the second device body 40B to the passage space 62.

In the example of FIG. 5B, a first light source 11 is attached to a lamp body (a first device body) 40C that is hanged, with a hook 46, from a second device body 40B installed to a ceiling 101. The first light source 11 attached to the lamp body 40C is configured to light display spaces 61 of showcases 50 placed on opposite sides (left side and right side in FIG. 5B) of the passage space 62. That is, the first light source 11 is configured to light a lighting area (a first lighting area) A3 set on both sides of the passage space 62. In this example, first and second detectors 21 and 22 are housed in the second device body 40B. The second detector 22 has a detection area that is set to a whole of the passage space 62, and is configured to detect human presence or absence in the passage space 62. The first detector 21 has detection areas that are set to nearer sides to the articles 70 displayed in the display spaces 61 than the detection area of the second detector 22. The first detector 21 is configured to detect a motion of a human for stretching one's hand to take an article 70 displayed in either of the display spaces 61 on opposite sides of the passage space 62.

In the lighting system of this example, if the second detector 22 detects human presence in the passage space 62 and supplies a controller 30 with a human detection signal, the controller 30 controls a first lighting circuit 13 to increase an optical output of the first light source 11. If the optical output of the first light source 11 is increased, the articles 70 displayed in the display spaces 61 on both sides are lit more brightly than the passage space 62, and accordingly the attention of a human in the passage space 62 can be directed to the articles 70. If a human P1 in the passage space 62 stretches one's hand to take an article 70 displayed in either one of the display spaces 61, the first detector 21 detects human presence (presence of part of a human body) and supplies the controller 30 with a human detection signal. If receiving the human detection signal from the first detector 21, the controller 30 controls a second lighting circuit 14 to increase an optical output of a second light source 12. If the human P1 takes an article 70 from articles 70 displayed in the display space 61, the article 70 taken in one's hand is lit brightly by the light of the second light source 12 of which the optical output is increased. Accordingly, characters or graphics depicted in the article 70 can be easily seen and the article 70 itself looks better.

In short, the lighting system according to the example of FIG. 5B includes the first device body 40C that houses the first light source 11 and the second device body 40B that houses the second light source 12. The second device body 40B is installed to a ceiling 101, above the passage space 62, of a room in a building. The first device body 40C is hanged from the second device body 40B. The first light source 11 is configured to emit light diagonally downward from the first device body 40C to the display space 61. The second light source 12 is configured to emit light downward from the second device body 40B to the passage space 62.

In the example of FIG. 5C, each of a shelf board 53 in a showcase 50 is provided, on a front side (a passage space 62 side) thereof, with a lamp body (a first device body) 40D, and a first light source 11 and a first lighting circuit 13 are housed in each lamp body 40D. Each of the first light sources 11 housed in a lamp body 40D is configured to emit light upward and downward, and to light part of a display space 61 near the passage space 62. In this example, a controller 30, a first detector 21 and a second detector 22 are housed in a device body (a second device body) 40B. The controller 30 housed in the device body 40B and the first lighting circuits 13 housed in the lamp bodies 40D have a wireless communication function, and the controller 30 is configured to wirelessly transmit a control signal(s) to the first lighting circuits 13. The first lighting circuits 13 housed in the individual lamp bodies 40D have individual addresses, and the controller 30 is configured to transmit a wireless signal to a desired first lighting circuit 13 by specifying an address.

In the lighting system of this example, if detecting human presence in the passage space 62, the second detector 22 supplies the controller 30 with a human detection signal. If receiving the human detection signal from the second detector 22, the controller 30 wirelessly transmits, to a first lighting circuit 13 housed in a lamp body 40D that faces the passage space 62, a control signal for increasing an optical output of a first light source 11. If a first lighting circuit 13 receives a control signal that designates itself from the controller 30, the first lighting circuit 13 increases the optical output of the first light source 11 based on the received control signal. Therefore, the optical output of the first light source 11 placed on the front side of the shelf board 53 facing the passage space 62 is increased, and the articles 70 displayed on the shelf board 53 facing the passage space 62 are lit brightly. As a result, the attention of a human in the passage space 62 can be directed to the articles 70. If a human P1 in the passage space 62 stretches one's hand to take an article 70 displayed in either one of the display spaces 61, the first detector 21 detects human presence (presence of part of a human body) and supplies the controller 30 with a human detection signal. If receiving the human detection signal from the first detector 21, the controller 30 controls the second lighting circuit 14 to increase an optical output of the second light source 12. If the human P1 takes an article 70 from articles 70 displayed in the display space 61, the article 70 taken in one's hand is lit brightly by the light of the second light source 12 of which the optical output is increased. Accordingly, characters or graphics depicted in the article 70 can be easily seen and the article 70 itself looks better.

In short, the lighting system according to the example of FIG. 5C includes: the showcase 50 which has a shelf board 53 and defines the display space 61; the first device body 40D that houses the first light source 11; and the second device body 40B that houses the second light source 12. The first device body 40D is installed on an end, on a side of the passage space 62, of the shelf board 53. The second device body 40B is installed to a ceiling 101, above the passage space 62, of a room in a building. The first light source 11 is configured to emit light upward and/or downward from the first device body 40D. The second light source 12 is configured to emit light downward from the second device body 40B to the passage space 62.

In the example of FIG. 5D, the lighting system includes lamp bodes (first device bodies) 40E each of which is shaped like a rod and which are provided on both ends of a showcase 50 in the width direction thereof. Each of the lamp bodies 40E is connected to a top and a bottom of a pillar member 51 of the showcase 50 via two arms 47. A first light source 11, which is a linear light source, and a first lighting circuit 13 are housed in each of the lamp bodies 40E. Each of the lamp bodies 40E is positioned on a front side of shelf boards 53, and the first light sources 11 housed in the lamp bodies 40E laterally light the display space 61. In this example, a controller 30, a first detector 21 and a second detector 22 are housed in a device body (a second device body) 40B. The controller 30 housed in the device body 40B and the first lighting circuits 13 housed in the lamp bodies 40E have a wireless communication function, and the controller 30 is configured to wirelessly transmit a control signal(s) to the first lighting circuits 13. The first lighting circuits 13 housed in the individual lamp bodies 40E have individual addresses, and the controller 30 is configured to transmit a wireless signal to a desired first lighting circuit 13 by specifying an address. Control operation of the lighting system of this example is similar to that of the example of FIG. 5C, and detailed explanation thereof is omitted.

In short, the lighting system according to the example of FIG. 5D includes the first device body 40E that houses the first light source 11 and the second device body 40B that houses the second light source 12. The first device body 40E shaped like a rod is placed between the display space 61 and the passage space 62 while the longitudinal direction of the first device body 40E corresponds to the vertical direction. The second device body 40B is installed to a ceiling 101, above the passage space 62, of a room in a building. The first light source 11 is configured to emit light horizontally from the first device body 40E. The second light source 12 is configured to emit light downward from the second device body 40B to the passage space 62.

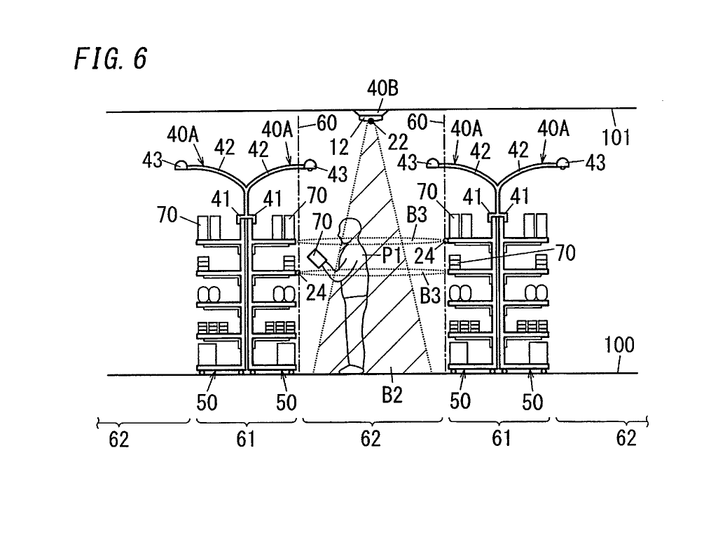

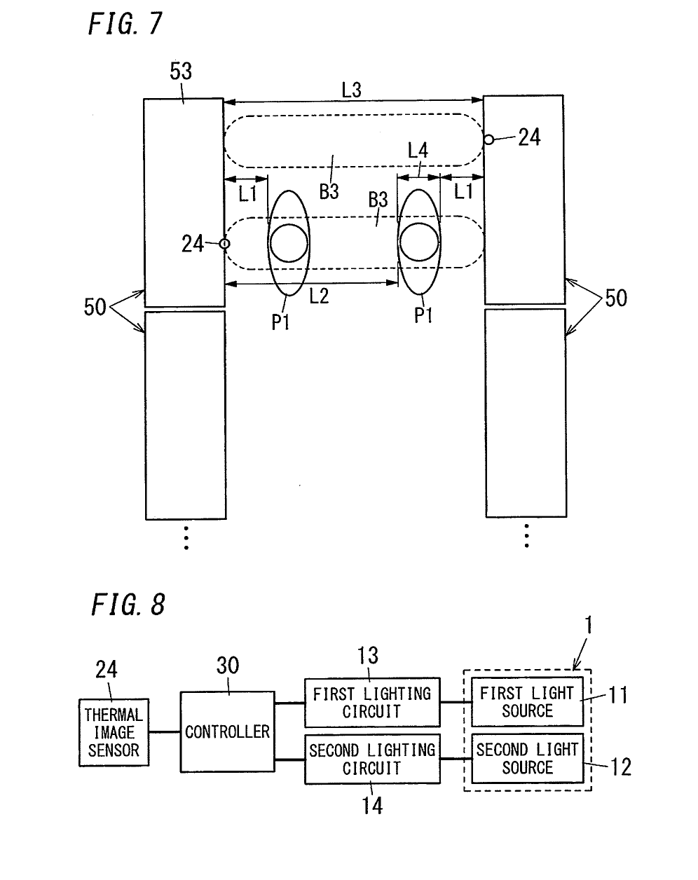

In each of the above examples, a first detector 21 is formed of an infrared detector of which detection area is set to a nearer side to articles 70 than a detection area of the second detector 22, but may be formed of a ranging (distance) sensor that is configured to measure a distance to a target object. A lighting system according to this example is explained with reference to FIGS. 6 and 7.

The lighting system according to the example of FIGS. 6 and 7 has a similar configuration to that shown in FIG. 5A, and includes a ranging sensor(s) 24 in place of the first detector 21. The ranging sensor 24 is attached to a front side of a shelf board 53. The ranging sensor 24 is configured to emit an infrared light, and to measure a length of time from a point in time at which it emits an infrared light to a point in time at which it receives the reflected infrared light, thereby detecting presence or absence of a target object and also measuring a distance to the target object when the target object is present. As shown in FIGS. 6 and 7, the ranging sensor 24 is attached to the shelf board 53 so that a detection area B3 of the ranging sensor 24 is directed in a depth direction of a showcase 50 on a side of the passage space 62, and is configured to detect presence or absence of a target object (human body) in the detection area B3 and also to measure a distance to the target object when the target object is present. Here, the ranging sensor 24 and a controller 30 have a wireless communication function. If detecting presence of a target object, the ranging sensor 24 wirelessly transmits, to the controller 30, information about the distance to the target object. If receiving, from the ranging sensor 24, a distance value to the target object, the controller 30 compares the received distance value with a predetermined threshold value L1. If the distance value is smaller than the threshold value L1, the controller 30 determines that a human (a target object) stretches one's hand into the display space 61, and then controls a second lighting circuit 14 to increase an optical output of a second light source 12.

In a preferred aspect, the controller 30 is also configured to determine an approach of a human to a showcase 50 (referred to as “an opposite showcase”) that is placed opposite side of a passage space 62 from a showcase 50 to which the ranging sensor 24 is attached, based on a distance value measured with the ranging sensor 24. In this aspect, the controller 30 has a threshold value L2 (L2=L3−L4−L1) for the opposite showcase 50, where L3 is a width of the passage space 62 and L4 is a thickness of a human body (see FIG. 7). If receiving, from the ranging sensor 24, a distance value to a target object, the controller 30 compares the received distance value with the threshold value L2. If the distance value is the threshold value L2 or more and also is less than a value L3−L4, the controller 30 determines that a human P1 (a target object) stretches one's hand into the opposite showcase 50 to take an article 70, and then controls a second lighting circuit 14 to increase an optical output of a second light source 12.

As described above, in the lighting system according to the example of FIGS. 6 and 7, the first detector 21 is realized by a ranging sensor. The ranging sensor may also be configured to detect human presence or absence in a passage space 62. That is, first and second detectors 21 and 22 may be formed of a single sensor (such as a ranging sensor 24).

In the above-mentioned examples, only human presence or absence in a passage space 62 is detected with a second detector 22, but a lighting system may be configured to further detect whether a human stops or not in the passage space 62. A lighting system according to this example is explained with reference to FIG. 8.

As shown in FIG. 8, the lighting system of this example includes a thermal image sensor 23. The thermal image sensor 23 is a sensor configured to measure temperature distribution in an imaging area to output a measured result as a thermal image. For example, the thermal image sensor 23 is configured to capture an image of a floor side area including a display space 61 and a passage space 62 from an upper side thereof at prescribed intervals to sequentially supply a thermal image data to a controller 30. The controller 30 is configured to determine human presence or absence in detection areas based on the thermal image(s) captured by the thermal image sensor 23. As long as the thermal image sensor 23 can capture an image, of an area in which human presence or absence should be detected, from a place higher than a human, the thermal image sensor 23 may be housed in a device body 40A (see FIG. 1A) or attached to a ceiling, a wall, or a showcase 50.

A control operation of the lighting system of this example is explained. In an initial state when the lighting system starts operating, if a thermal image is supplied from the thermal image sensor 23 to the controller 30, the controller 30 stores the thermal image in the initial state as a background image into a memory (an internal memory or an external memory). In the initial state, the controller 30 detects human absence in the display space 61 and the passage space 62, and sets, to “0”, the number of humans in each of a first region and a second region that are previously set in the thermal image. Here, the first region corresponds to a first detection area B1, while the second region corresponds to a second detection area B2. That is, the second region (B2) is an area for detecting human presence or absence in the passage space 62. The first region (B1) is an area that is near to the articles 70 displaced in the display space 61 than the second region (B2).

In the initial state, if the controller 30 detects human absence in both of the first and second regions, the controller 30 operates first and second light sources 11 and 12 at a more reduced level in comparison with a case where human presence is detected.

Subsequently, the controller 30 periodically receives a thermal image from the thermal image sensor 23 to calculate a difference image between the thermal image from the thermal image sensor 23 and the background image stored in the memory and then to generate a binary image (a black and white image) by binarizing the difference image with a prescribed threshold. The controller 30 has preset upper and lower limits with respect to a size (a human body size) that is previously derived from a thermal image including a human based on conditions such as an installation location of the thermal image sensor 23, an angle for capturing a thermal image and average physique. From the binary image, the controller 30 extracts (at least) a pixel region formed of pixels different from the background image to detect human presence if a size of the pixel region is equal to or larger than the lower limit and equal to or smaller than the upper limit. If the controller 30 detects human presence, the controller 30 determines the pixel region representing human presence is in any one of the first and second regions or in both of them. If the pixel region is in not both of them but the second region, the controller 30 measures a detection time representing continuously human presence. The background image captured in the initial state during human absence may continue to be used, or the background image may be periodically renewed.

If a detection time representing human presence in the second region is equal to or larger than a reference value (e.g., 5 seconds) based on thermal images captured by the thermal image sensor 23, the controller 30 determines that a human stops in the second region, and then supplies a first lighting circuit 13 with a control signal for increasing an optical output of the first light source 11. If receiving the control signal, the first lighting circuit 13 increases electric power to be supplied to the first light source 11, thereby increasing the optical output of the first light source 11. Thus, if the optical output of the first light source 11 is increased, the attention of a human (a customer) in the passage space 62 can be directed to articles 70 displayed on the display space 61 because the articles 70 are lit brightly.

The controller 30 may be configured, if determining that a human stops in the second region, to allow an information device 80 to perform a notification operation. Thus, the information about the articles 70 and the like can be provided to a human stopping in the passage 62. In the lighting system according to the example of FIG. 8, a first detector configured to detect human presence or absence in a detection area set in the passage space 62 on a side of articles; a second detector configured to detect human presence or absence in the passage space 62; and a third detector configured to detect whether a human passes through or stops in the passage space 62, are realized by the thermal image sensor 23 and a processing function of the controller 30.

If detecting human presence (detecting presence of part of a human) in the first region based on a thermal image supplied from the thermal image sensor 23, the controller 30 supplies a second lighting circuit 14 with a control signal for increasing an optical output of the second light source 12. If receiving the control signal, the second lighting circuit 14 increases electric power to be supplied to the second light source 12, thereby increasing the optical output of the second light source 12. If the optical output of the second light source 12 is increased, an article 70 taken in one's hand is lit brightly, and accordingly characters or graphics depicted in an article 70 can be easily to see and the article 70 itself looks better.

If a predetermined time elapses from a point in time at which the controller 30 detects human absence in the first region based on a thermal image supplied from the thermal image sensor 23, the controller 30 supplies the second lighting circuit 14 with a control signal for decreasing the optical output of the second light source 12, thereby decreasing the optical output of the second light source 12. It is preferable that when decreasing the optical output of the second light source 12, the second lighting circuit 14 gradually change the optical output at a speed such that the change in the optical output is imperceptible and the atmosphere of the store space is not spoiled.

If a predetermined time elapses from a point in time at which the controller 30 detects human absence in the second region based on a thermal image supplied from the thermal image sensor 23, the controller 30 supplies the first lighting circuit 13 with a control signal for decreasing the optical output of the first light source 11. If receiving the control signal, the first lighting circuit 13 decreases electric power to be supplied to the first light source 11, thereby decreasing the optical output of the first light source 11.

It is preferable that when decreasing the optical output of the first light source 11, the first lighting circuit 13 gradually change the optical output at a speed such that the change in the optical output is imperceptible and the atmosphere of the store space is not spoiled.

In the lighting system of this example, even when detecting human presence in the second region based on a thermal image supplied from the thermal image sensor 23, the controller 30 does not necessarily increases the optical output of the first light source 11. That is, if the detection time is shorter than the predetermined reference time, the controller 30 determines that a human passes through the second region, and keeps the optical output of the first light source 11 at a reduced level. Accordingly, in a case where a human passes through the passage space 62, the optical output of the first light source 11 is not increased even when the human comes in the passage space 62. As a result, consumed energy can be reduced.

That is, the lighting system according to the example of FIG. 8 includes a third detector (the thermal image sensor 23 and the controller 30) configured to detect whether a human passes through or stops in the passage space 62. The controller 30 is configured, in a case where the second detector detects human presence and the third detector detects a human passing through the passage space 62, to decrease the optical output of the first light source 11 in comparison with a case where the third detector detects a human stopping in the passage space 62. Since the first light source 11 is operated at a reduced level when a human passes through the passage space 62, consumed energy can be reduced.

In the lighting system according to the example of FIG. 8, the first light source 11 is operated at a reduced level when a human passes through the passage space 62, and the optical output of the first light source 11 is increased when a human stops in the passage space 62. However, this example is not limited to this configuration. For example, the lighting system may be configured so that: the first light source 11 is lit at a fifth light output level in a case of detecting human absence; the optical output of the first light source 11 is increased to a six light output level (brighter than the fifth light output level) when a human passes through in the passage space 62; and the optical output of the first light source 11 is further increased to a seventh light output level (brighter than the sixth light output level) when a human stops in the passage space 62.

In the lighting system according to the example of FIG. 8, the controller 30 is configured to detect human presence or absence and detect a human stopping in the passage space 62 based on the thermal image obtained from the thermal image sensor 23, but a sensor for detecting a human is not limited to the thermal image sensor 23.

For example, an image sensor for capturing a visible light image may be used in order to detect human presence or absence and also detect whether or not a human stops based on an image captured by the image sensor. Examples of the image sensor for capturing a visible light image include a CCD (Charged Coupled Device) image sensor, and a CMOS (Complementary Metal Oxide Semiconductor) image sensor. The number of thermal image sensors 23 or image sensors may be one or more. Preferably, the number of thermal image sensors 23 or image sensors is set to a quantity required for detection areas to be captured. The third detector may be formed of an infrared detector or a ranging sensor. For example, it is possible to determine that a human stops in the passage space 62 if a detection time during which the infrared detector or the ranging sensor detects human presence continues for a predetermined reference time.

Preferably, the lighting system according to the example of FIG. 8 includes the information device 80 that is placed in the display space 61 and is configured to notify of information related to the articles 70 displayed in the display space 61. Preferably, the controller 30 is configured to cause the information device 80 to provide the information related to the articles 70 if the third detector detects a human stopping in the passage space 62. Accordingly, it is possible to notify a human stopping in the passage space 62 of information related to the articles 70.

In the lighting system according to the example of FIG. 8, the first to third detectors are realized by a single sensor (the thermal image sensor 23), but may be formed of two or three sensors having any one functions of the first to third detectors.

In the above-mentioned examples, a luminaire installed in each showcase 50 includes a first detector 21, a second detector 22 and a controller 30, but one controller 30 may be configured to control two or more luminaires. Each of a first detector 21 and a second detector 22 may have a detection area covering display and passage spaces 61 and 62 of two or more showcases 50. If a second detector 22 detects human presence in a passage space 62, the controller 30 increases an optical output of a first light source 11 for lighting a display space 61 of a showcase 50 facing a detection area in which human presence is detected. If a first detector 21 detects human presence in a display space 61, the controller 30 increases an optical output of a second light source 12 for lighting a passage space 62 facing a detection area in which human presence is detected. In this case, the controller 30 stores each address information of first and second light sources 11 and 12, and installation location associated with each address information.

In the above-mentioned examples, a lighting system is applied to a retail store such as a convenience store or the like, but may be applied to a library, a book store, an art gallery or a museum. In an art gallery or a museum, if a switch for reproducing a voice guide near an exhibit(s) is provided, a first detector may be configured to detect an operation for turning on the switch.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A lighting system comprising:
a light source configured to light a display space for displaying articles and a passage space facing the display space;
a first detector configured to detect presence or absence of part of a human body in a first detection area;
a second detector configured to detect human presence or absence in a second detection area; and
a controller configured to control an optical output of the light source, wherein
the second detection area contains a whole or part of the passage space,
the first detection area is set to a nearer side to the article than the second detection area, and
the controller is configured to control the optical output of the light source so that:
(a) in a case of detecting human absence in which both of the first and second detectors detect human absence, the light source is operated at a reduced light output level in comparison with a case of detecting human presence in which at least one of the first and second detectors detects human presence;
(b) if the second detector detects human presence, illuminance in the display space is increased in comparison with the case of detecting human absence in which both of the first and second detectors detect human absence; and
(c) if the first detector detects human presence, illuminance in each of the passage space and the display space is increased in comparison with the case of detecting human absence in which both of the first and second detectors detect human absence.

2. The lighting system according to claim 1, wherein the light source comprises:
a first light source configured to mainly light the display space; and
a second light source configured to mainly light the passage space, and
the controller is configured:
(a) in the case of detecting human absence in which both of the first and second detectors detect human absence, to more decrease optical outputs of the first and second light sources in comparison with the case of detecting human presence in which at least one of the first and second detectors detects human presence;
(b) if the second detector detects human presence, to more increase the optical output of the first light source in comparison with the case of detecting human absence in which both of the first and second detectors detect human absence; and
(c) if the first detector detects human presence, to more increase the optical outputs of both of the first and second light sources in comparison with the case of detecting human absence in which both of the first and second detectors detect human absence.

3. The lighting system according to claim 1, wherein
the light source comprises:
a first light source configured to mainly light the display space; and
a second light source configured to mainly light the passage space, and
the controller is configured:
(a) in the case where both of the first and second detectors detect human absence, to light the first and second light sources at first and second light output levels, respectively;
(b) if the second detector detects human presence, to light the first light source at a third light output level brighter than the first light output level; and
(c) if the first detector detects human presence, to light the second light source at a fourth light output level brighter than the second light output level.

4. The lighting system according to claim 2, wherein the first light source is configured to light, from a side of the passage space, a boundary face between the display space and the passage space.

5. The lighting system according to claim 2, further comprising an information device configured to notify of information related to the articles displayed in the display space, wherein
the controller is configured to allow the information device to provide the information on the articles if the second detector detects human presence.

6. The lighting system according to claim 2, further comprising a third detector configured to detect whether a human passes through or stops in the passage space, wherein
the controller is configured, in a case where the third detector detects a human passing through the passage space, to more decrease the optical output of the first light source in comparison with a case where the third detector detects a human stopping in the passage space.

7. The lighting system according to claim 6, further comprising an information device configured to notify of information related to the articles displayed in the display space, wherein
the controller is configured to allow the information device to provide the information on the articles if the third detector detects a human stopping in the passage space.

8. The lighting system according to claim 1, wherein the first and second detectors are formed of a single sensor.

9. The lighting system according to claim 1, wherein the first detector and the second detector are formed of individual two sensors.

10. The lighting system according to claim 5, wherein at least two of the first to third detectors are formed of a single sensor.

11. The lighting system according to claim 2, further comprising a device body that comprises a base, a housing, and an arm connecting the base and the housing, wherein
the base is attached to a showcase which defines the display space,
the arm extends from a side of the display space to a side of the passage space so that the housing is placed above the passage space,
the first light source, the second light source, the first detector and the second detectors are provided to the housing,
the first light source is configured to emit light diagonally downward from the housing to the display space, and
the second light source is configured to emit light downward from the housing to the passage space.

12. The lighting system according to claim 2, further comprising a device body that houses the first light source, the second light source, the first detector and the second detectors,
the device body is installed to a ceiling, above the passage space, of a room,
the first light source is configured to emit light diagonally downward from the device body to the display space, and
the second light source is configured to emit light downward from the device body to the passage space.

13. The lighting system according to claim 2, further comprising a first device body that houses the first light source and a second device body that houses the second light source, wherein
the first device body comprises a base, a housing, and an arm connecting the base and the housing,
the base is attached to a showcase which defines the display space,
the arm extends from a side of the display space to a side of the passage space so that the housing is placed above the passage space,
the first light source is provided to the housing,
the second device body is installed to a ceiling, above the display space, of a room,
the first light source is configured to emit light diagonally downward from the housing to the display space, and
the second light source is configured to emit light downward from the second device body to the passage space.

14. The lighting system according to claim 2, further comprising a first device body that houses the first light source and a second device body that houses the second light source, wherein
the second device body is installed to a ceiling, above the display space, of a room,
the first device body is hanged from the second device body,
the first light source is configured to emit light diagonally downward from the first device body to the display space, and
the second light source is configured to emit light downward from the second device body to the passage space.

15. The lighting system according to claim 2, further comprising: a showcase which has a shelf board and defines the display space; a first device body that houses the first light source; and a second device body that houses the second light source, wherein
the first device body is installed on an end of the shelf board on a side of the passage space,
the second device body is installed to a ceiling, above the display space, of a room,
the first light source is configured to emit light upward and/or downward from the first device body, and
the second light source is configured to emit light downward from the second device body to the passage space.

16. The lighting system according to claim 2, further comprising a first device body that houses the first light source and a second device body that houses the second light source, wherein
the first device body shaped like a rod is placed between the display space and the passage space while a longitudinal direction thereof corresponds to the vertical direction,
the second device body is installed to a ceiling, above the display space, of a room,
the first light source is configured to emit light horizontally from the first device body, and
the second light source is configured to emit light downward from the second device body to the passage space.
